(19) United States
(12) Patent Application Publication
(10) Pub. No.: US 2007/0118237 A1
(43) Pub. Date: May 24, 2007

(54) AUTOCONTROL SIMULATING SYSTEM AND METHOD

(76) Inventor: Chun-Chieh Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,136

(22) Filed: Jun. 27, 2006

(30) Foreign Application Priority Data
Nov. 18, 2005 (CN) 200510101513.2

(51) Int. Cl. G05B 17/00; G05B 23/02

(52) U.S. Cl. 700/31; 700/29

(57) ABSTRACT

An autocontrol method is provided for creating a simulated model that represents an autocontrol system. The autocontrol system includes a controller, a sensor and a plant. The simulated model includes a simulated controller, a simulated sensor, and a simulated plant corresponding to the controller, the sensor, and the plant respectively. The autocontrol simulating method includes steps of: loading parameter values of the controller and the sensor, the parameter values of the controller and the sensor being used as values for the simulated controller and the simulated sensor; setting parameter values of the simulated plant; calculating values for characteristic indicators of the simulated model; and depicting characteristic curves of the simulated model based on the values for characteristic indicators. A related autocontrol method for implementing the autocontrol method is also disclosed.

### FIELD OF THE INVENTION

This invention relates to simulating systems and methods and, more particularly, to a simulating system for an autocontrol system and a simulating method thereof.

### DESCRIPTION OF RELATED ART

Autocontrol systems are widely used in modern electronic industry because autocontrol systems can reduce labor costs and improve control accuracy. In general, the autocontrol system includes a controller, a plant, and a sensor. The controller sends control commands to the plant to control operations of the plant. The sensor retrieves states of the plant and transmits information on the states of the plant to the controller. Based on the information on the states of the plant, the controller modifies the control commands to conform to the states of the plant. The controller has some parameters whose values can be modified to conform to different applications.

In a development and/or an improvement of the autocontrol system, parameter values should be adjusted to be optimal so as to make the autocontrol system achieve a maximum performance. During the adjustment, a testing apparatus is connected to the autocontrol system and used to test whether the parameters values for the autocontrol system are optimal. Therefore, the autocontrol system is required to participate in the whole adjustment and testing process. However, it is troublesome to have an entire autocontrol system participate in the whole adjustment and testing process, especially when the autocontrol system is in a large size.

Therefore, a simulating system for simulating the autocontrol system is desired.

### SUMMARY OF THE INVENTION

An autocontrol simulating system is used for creating a simulated model that represents an autocontrol system. The autocontrol system includes a controller and a plant. The simulated model includes a simulated controller and a simulated plant corresponding to the controller and the plant respectively. The autocontrol simulating system includes a loading module, a first adjusting module, a calculating module, and a depicting module. The loading module is used for loading parameter values of the controller. The loaded parameter values of the controller are used as parameter values of the simulated controller. The first adjusting module is used for adjusting parameter values of the simulated plant. The calculating module is used for calculating values of characteristic indicators of the simulated plant. The depicting module is used for depicting characteristic curves of the simulated plant based on the values of characteristic indicators.

An autocontrol method is provided for creating a simulated model that represents an autocontrol system. The autocontrol system includes a controller and a plant. The simulated model includes a simulated controller and a simulated plant corresponding to the controller and the plant respectively. The autocontrol simulating method includes steps of: loading parameter values of the controller, the parameter values of the controller being used as values of the simulated controller; setting parameter values of the simulated plant; calculating values of characteristic indicators of the simulated plant; and depicting characteristic curves of the simulated plant based on the values of characteristic indicators.

A storage medium is recorded with an application program. The application program has a computer executable steps of: setting parameter values of a simulated model having a simulated controller, a simulated sensor and a simulated plant; calculating values for characteristic indicators of the simulated model; and depicting characteristic curves of the simulated model based on the values for characteristic indicators of the simulated model.

Other advantages and novel features will become more apparent from the following detailed description of preferred embodiments when taken in conjunction with the accompanying drawings, in which:

### BRIEF DESCRIPTION OF THE DRAWINGS

Many aspects of the autocontrol simulating system and the autocontrol simulating method thereof can be better understood with reference to the following drawings. The components in the drawings are not necessarily to scale, the emphasis instead being placed upon clearly illustrating the principles of the present disc drive. Moreover, in the drawings, like reference numerals designate corresponding parts throughout the several views.

FIG. 1 is a block diagram of an autocontrol system, the autocontrol system including a controller, a sensor, and a plant;

FIG. 2 is a block diagram of an autocontrol simulating system, the simulating system creating a simulated model including a simulated controller, a simulated sensor, and a simulated plant;

FIG. 3 is flow chart illustrating a simulating procedure of the autocontrol simulating system of FIG. 1;

FIG. 4 is a block diagram of a disc drive;

FIG. 5 is an exemplary user interface of the autocontrol simulating system of FIG. 1 used for adjusting parameters of the simulated plant; and

FIG. 6 is an exemplary user interface of the autocontrol simulating system of FIG. 1 used for adjusting parameters of the simulated controller and the simulated sensor.

### DETAILED DESCRIPTION OF THE INVENTION

Reference will now be made to the drawings to describe the preferred embodiment of the present autocontrol simulating system and the present simulating method, in detail.

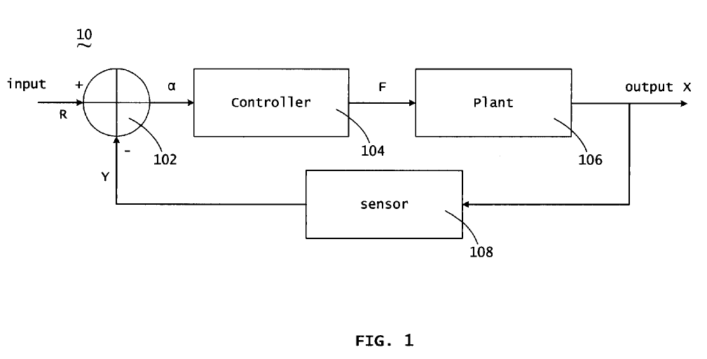

Referring to FIG. 1, a block diagram of an autocontrol system 10 is illustrated. The autocontrol system 10 includes an operator 102, a controller 104, a plant 106, and a sensor 108. The controller 104 is used for controlling operations of the plant 106. The sensor 108 is used for sensing states of the plant 106 and feeding back the states of the plant 106 to the controller 104.

An exemplary working procedure of the autocontrol system 10 is as follows: first, an external input R is inputted to the operator 102. At the same time, the sensor 108 feeds back a state signal Y representing the states of the plant 106 to the operator 102. Second, the operator 102 subtracts the state signal Y from the external input R to get an input signal α of the controller 104. Third, the controller 104 generates a control signal F based on the input signal α of the controller 104. The control signal F is then sent to the plant 106. Finally, the plant 106 generates an output signal X based on the control signal F. The output signal X is also outputted to the sensor 108.

Each of the input signal α, the control signal F, the output signal X, and the state signal Y depends on a time parameter t. According to Laplace transformation theorem, signals in the time domain (also called t-domain) can be transformed into a complex frequency domain (also called s-domain). That is, each of the input signal α, the control signal F, the output signal X, and the state signal Y can be transformed to depend on a complex frequency parameter s.

According to autocontrol principles, the input signal α(s) of the controller 104 can be defined as follows:
α(s)=R(s)−Y(s) (1)
wherein R(s) represents the external input signal, and Y(s) represents the state signal fed back to the operator 102 by the sensor 108 concurrently.

It is presumed that the sensor 108 includes a transfer function H(s). The state signal Y(s) can be defined as follows:
Y(s)=H(s)*X(s) (2)
wherein H(s) represents the transfer function of the sensor 108, and X(s) represents the output signal of the plant 106.

It is presumed that the controller 104 includes a transfer function C(s). The control signal F(s) can be defined as follows:
F(s)=C(s)*α(s) (3)
wherein C(s) represents the transfer function of the controller 104, and α(s) represents the input signal of the controller 104.

It is presumed that the plant 106 includes a transfer function G(s). The output signal X(s) can be defined as follows:
X(s)=G(s)*F(s) (4)
wherein G(s) represents the transfer function of the plant 106, and F(s) represents an output signal of the controller 104.

Based on the above-mentioned conditions (1), (2), (3) and (4), X(s) and R(s) can be represented by following expressions (5) and (6):
X(s)=G(s)*F(s)=G(s)*C(s)*α(s) (5)
R(s)=α(s)+Y(s)=α(s)+H(s)*X(s)=α(s)+H(s)*G(s)*C(s)*α(s) (6)

It is presumed that the autocontrol system 10 has a transfer function T(s). The transfer function T(s) of the autocontrol system 10 can be defined as follows:

$$\begin{matrix}T ( s ) = X ( s ) / R ( s ) \\ = ( G ( s ) * C ( s ) * α ( s ) ) / ( α ( s ) + H ( s ) * G ( s ) * C ( s ) * α ( s ) ) \\ = ( G ( s ) * C ( s ) ) / ( 1 + H ( s ) * G ( s ) * C ( s ) )\end{matrix} \qquad ( 7 )$$

Generally, the plant 106 can be regarded as a second order system and the transfer function G(s) of the plant 106 can be represented by the following expression:
G(s)=K/(Ts2+s+K) (8)
wherein s represents an variable parameter of the equation (8), K represents a invariable flexibility parameter of the plant 106, T represents an invariable time parameter of the plant 106.

The expression (8) can be transformed to another expression:
G(s)=ωₙ²/(²+2*s*ωₙ*ξ+ωₙ²) (9)
wherein ωₙ represents an undamped oscillation frequency of the second order system and satisfies: ωₙ=(K/T^{1/2}, ξ represents a damping ratio of the second order system and satisfies: ξ=1/(2*(K*T^{1/2}). The parameters K, T, ωₙ, and ξ are adjustable constant parameters.

Each of the transfer function C of the controller 104 and the transfer function H of the sensor 108 can be presumed as a linear compound function of three functions F₁(s), F₂(s), and F₃(s). The three functions F₁(s), F₂(s), and F₃(s) satisfy the following equations:
F₁(s)=aₚ (10)
F₂(s)=c₁/(a₁*s+b₁) (11)
F₃(s)=a_{D}*s+b_{D} (12)
wherein aₚ, C₁, a₁, b₁, a_{D}, and b_{D} are adjustable constant parameters.

According to the expressions (7), (9), (10), (11), and (12), the transfer function T(s) of the autocontrol system 10 can be determined by the adjustable constant parameters K, T, ωₙ, ξ, aₚ, c₁, a₁, b₁, a_{D}, and b_{D}, and variable parameter s. In order to make the autocontrol system 10 run in a best mode, each adjustable constant parameter should be given an optimal value. After every adjustment, a test should be done to determine whether the adjusted values are optimal.

In order to perform the tests, bode diagrams are used as evaluation indicators. Such bode diagrams include an amplitude-phase characteristic curve which reflects relationships between gain ratios M(ω) and frequencies of the autocontrol system 10, and a phase characteristic curve which reflects relationships between phase differences φ(ω) and frequencies of the autocontrol system 10. It is presumed that s satisfies an equation: s=j*ω, wherein j is an invariable coefficient, ω is a variable parameter that represents a frequency of the autocontrol system 10. Therefore, the transfer function T(s) of the autocontrol system 10 can be represented by T(j*ω). The gain ratio M(ω) between the input signal R and the output signal X of the autocontrol system 10 satisfies: M(ω)=/T(j*ω)/. The phase difference φ(ω) of the autocontrol system 10 satisfies: φ(ω)=<T(j*ω). Therefore, each of the adjustable constant parameters K, T, ωₙ, φ, aₚ, c₁, a₁, b₁, a_{D}, b_{D}, and j has an affect on the amplitude-phase characteristic curve and the phase characteristic curve. Each of the adjustable constant parameters K, T, ωₙ, φ, aₚ, c₁, a₁, b₁, a_{D}, b_{D}, and j should be give an optimal value to ensure the amplitude-phase characteristic curve and the phase characteristic curve in a predetermined form.

However, the adjustable constant parameters may depend on each other, thus making a design task of selecting an optimal value to each adjustable constant parameter more complicated and tedious.

In order to make the complicated and tedious tasks easier, an autocontrol simulating system 20 is used to create a simulated model to represent behavior characteristics of the autocontrol system 10. The simulated model includes a simulated controller corresponding to the controller 104, a simulated plant corresponding to the plant 106, and a simulated sensor corresponding to the sensor 108.

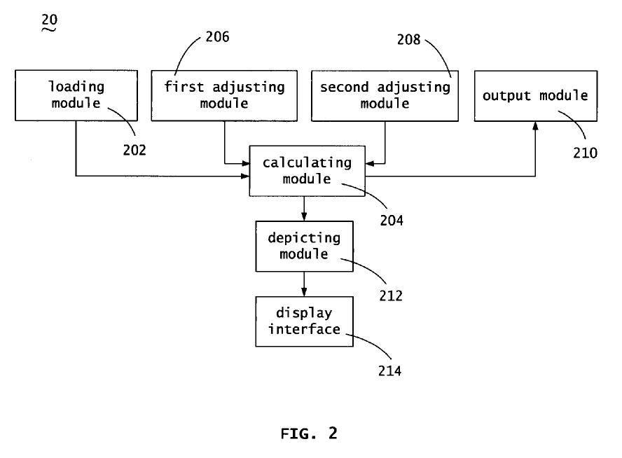

Referring to FIG. 2, a block diagram of the autocontrol simulating system 20 is illustrated. The autocontrol simulating system 20 includes a loading module 202, a calculating module 204, a first adjusting module 206, a second adjusting module 208, an output module 210, a depicting module 212, and a display interface 214. The loading module 202 is used for receiving a group of parameter values. The received parameter values include parameter values of the simulated controller and the simulated sensor. The received values can be obtained from an input terminal (not shown), or be read from a storing module (not shown) for storing given values of parameters.

The calculating module 204 is used for calculating depicting data of the simulated plant and the simulated model based on each group of parameter values.

The first adjusting module 206 is used for setting and adjusting the parameter values of the simulated plant, so as to make an amplitude-phase characteristic curve and a phase characteristic curve for the simulated plant substantially the same as those for the plant 106.

The second adjusting module 208 is used for adjusting the parameter values of the simulated controller and the simulated sensor to be “satisfied”. The output module 210 is used for outputting “satisfied” parameter values of the simulated controller and the simulated sensor.

The depicting module 212 is used for depicting an amplitude-phase characteristic curve and a phase characteristic curve based on the depicting data. The amplitude-phase characteristic curve and the phase characteristic curve are used to test whether a corresponding group of parameter values are “satisfied”. The display interface 214 is used for timely displaying the amplitude-phase characteristic curve and the phase characteristic curve for the corresponding group of parameter values.

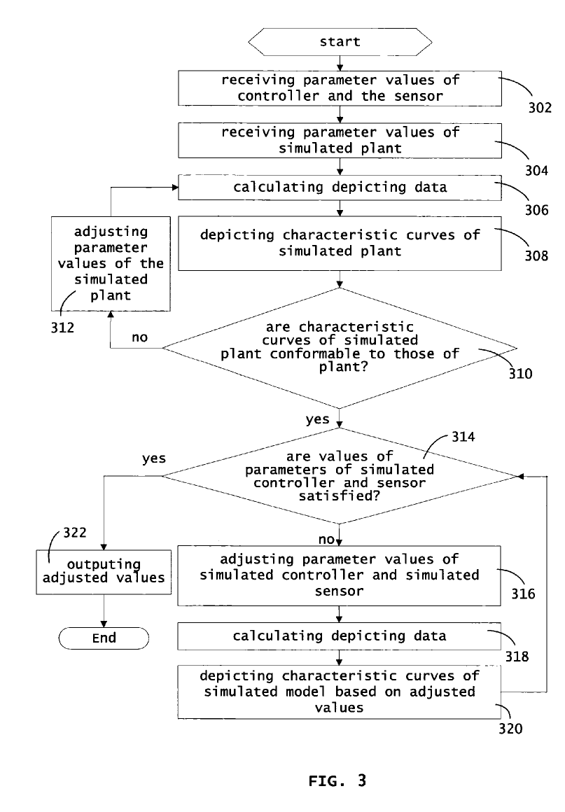

Referring to FIG. 3, a simulating procedure of the autocontrol simulating system 20 is illustrated. Firstly, in step 302, the loading module 202 receives parameter values of the controller 104 and the sensor 108. The received parameter values of the controller 104 and the sensor 108 are used as parameter values of the simulated controller and the simulated sensor, respectively.

Secondly, in step 304, the first adjusting module 206 receives parameter values of the simulated plant from an input terminal. The received parameter values of the controller 104 and the sensor 108, and the parameter values of the simulated plant are then transferred to the calculating module 204.

Thirdly, in step 306, the calculating module 204 calculates depicting data of the simulated plant based on the received parameter values of the controller 104, the sensor 108, and the simulated plant.

Based on the depicting data, the depicting module 212 depicts an amplitude-phase characteristic curve and a phase characteristic curve of the simulated plant to be displayed on the display interface 214 (step 308).

Then, in step 310, a conclusion is made as to whether the amplitude-phase characteristic curve and the phase characteristic curve of the simulated plant are conformable to those of the plant 106. In this embodiment, the amplitude-phase characteristic curve and the phase characteristic curve of the plant 106 are previously stored in the autocontrol simulating system 20. The amplitude-phase characteristic curve and the phase characteristic curve of the plant 106 are based on the received parameter values of the controller 104 and the sensor 108.

If the amplitude-phase characteristic curve and the phase characteristic curve of the simulated plant are not conformable to those of the plant 106, the procedure proceeds to step 312 where the parameter values of the simulated plant are re-adjusted while the parameter values of the simulated controller and the simulated sensor are kept unchanged. After re-adjustment in step 310, the procedure goes back to step 306.

If the amplitude-phase characteristic curve and the phase characteristic curve of the simulated plant are conformable to those of the plant 106, the simulated plant is proved “satisfied” to serve as a representation of the plant 106. The procedure proceeds to step 314 where another conclusion is made as to whether the parameter values of the simulated controller and the simulated sensor are “satisfied”.

If the parameter values of the simulated controller and the simulated sensor are not “satisfied”, the procedure proceeds to step 316 where the parameter values of the simulated controller and the simulated sensor are adjusted. Then, in step 318, the calculating module 204 calculates depicting data of the simulated model based on the adjusted parameter values of the simulated controller and the simulated sensor. Based on the depicting data of the simulated model corresponding to the adjusted values, the depicting module 212 depicts an amplitude-phase characteristic curve and a phase characteristic curve of the simulated model to be displayed on the display interface 314 (step 320). After that, the procedure goes back to step 314.

If the parameter values of the simulated controller and the simulated sensor are optimal, the procedure proceeds to step 322 where the parameter values of the simulated controller and the simulated sensor are outputted to the autocontrol system 10.

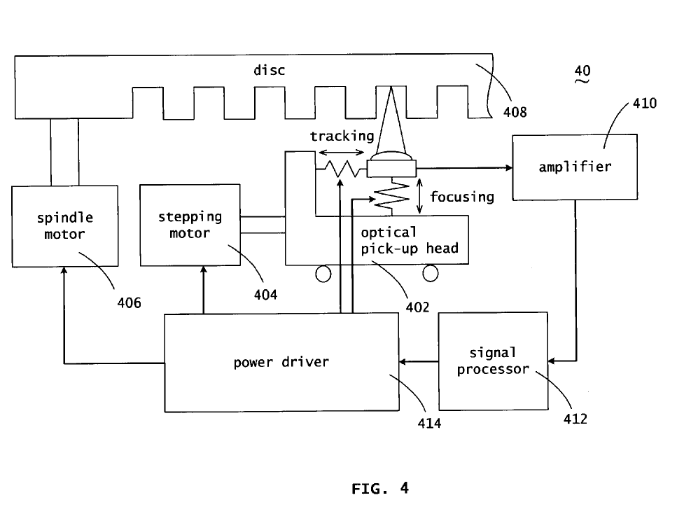

The autocontrol system 10 can be used in many applications, such as in a disc drive, a television, an air-conditioner, and a car. For simplicity of the description, a disc drive 40 is used as an example for illustration. Referring also to FIG. 4, the disc drive 40 includes an optical pick-up head 402, a stepping motor 404, a spindle motor 406, an amplifier 410, a signal processor 412, and a power driver 414. The spindle motor 406 spins to bring a disc 408 to spin. The stepping motor 404 spins to drive the optical pick-up head 402 to move so that the optical pick-up head 402 seeks a predetermined track of the disc 108. The optical pick-up head 402 receives a reflected light from the disc 408 and retrieves optical signals from the reflected light and then transforms the optical signals into electrical signals to be sent to the amplifier 410. The amplifier 410 amplifies the electrical signals to be sent to the signal processor 412. The signal processor 412 extracts tracking error signals and/or focusing error signals from the electrical signals and then generates servo control signals based on the tracking error signals and/or focusing error signals to be sent to the power driver 414. Based on the servo control signals, the power driver 414 outputs corresponding driving voltages to control the stepping motor 404 and the spindle motor 406 to spin, so as to drive the disc 408 to spin and the optical pick-up head to move in a desired pattern.

In the disc drive 40, the signal processor 412 and the power driver 414 cooperates with the optical pick-up head 402, the amplifier 410, the stepping motor 404 and the spindle motor 406 to function as the autocontrol system 10. The signal processor 412 cooperates with the power driver 414 to function as the controller 104. The optical pick-up head 402 functions as the sensor 108. The amplifier 410 functions as the operator 102. The stepping motor 404 and the spindle motor 406 function as the plant 106.

In order to simulate the autocontrol system 10 of the disc drive 40, the autocontrol simulating system 20 creates a simulated model representing the autocontrol system 10 of the disc drive 40. The simulated model includes a simulated plant corresponding to the stepping motor 404 and the spindle motor 406, a simulated controller corresponding to the signal processor 412 and the power driver 414.

Referring to FIG. 3 again, in step 310, the characteristic curves for the stepping motor 404 and the spindle motor 406 are obtained by measuring and input and an output of the spindle motor 406 and the stepping motor 404.

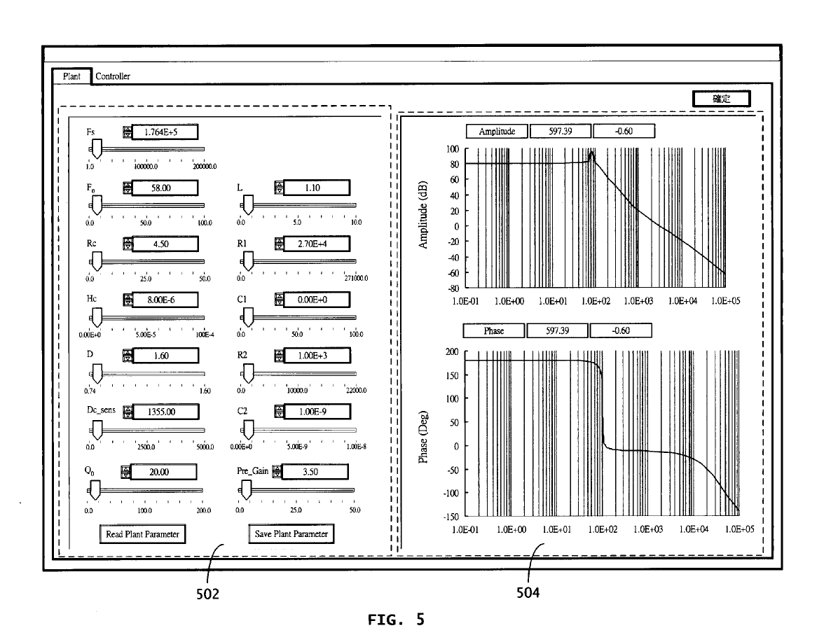

Referring to FIG. 5, an exemplary user interface 50 of the autocontrol simulating system 20 used for adjusting parameters of the simulated plant corresponding to the stepping motor 404 and the spindle motor 406 is illustrated. The user interface 50 includes a first adjusting area 502 for adjusting the parameter values of the simulated plant, and a first display area 504 for displaying an amplitude-phase characteristic curve and a phase characteristic curve of the simulated plant. After a user selects a group of parameter values of the simulated plant, a corresponding amplitude-phase characteristic curve and a corresponding phase characteristic curve of the simulated plant are displayed in the first display area 504 in an instant manner.

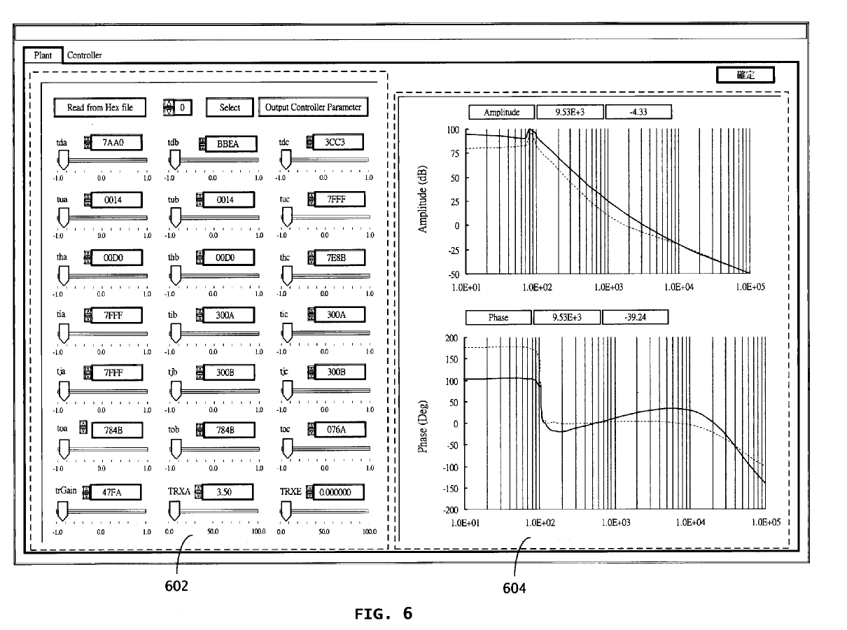

Referring to FIG. 6, an exemplary user interface 60 of the autocontrol simulating system 20 used for adjusting parameters of the simulated controller corresponding to the signal processor 412 and the power driver 414 is illustrated. The user interface 60 includes a second adjusting area 602 for adjusting the parameter values of the simulated controller, and a second display area 604 for displaying an amplitude-phase characteristic curve and a phase characteristic curve of the simulated model. After a user selects a group of parameter values of the simulated controller, a corresponding amplitude-phase characteristic curve and a corresponding phase characteristic curve of the simulated model are displayed in the second display area 604 in an instant manner. In the second display area 604, curves in dashed lines corresponds to parameter values of the simulated controller before adjustment, whist curves in continuous lines corresponds to parameter values of the simulated controller after adjustment. By comparing the curves in the dashed lines and in the continuous lines, effects of each parameter on the curves will be visible.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. An autocontrol simulating system for creating a simulated model representing an autocontrol system having a controller and a plant, the simulated model having a simulated controller and a simulated plant corresponding to the controller and the plant respectively, the autocontrol simulating system comprising:
a loading module, the loading module being used for loading parameter values of the controller, the parameter values of the controller being used as parameter values of the simulated controller;
a first adjusting module, the first adjusting module being used for adjusting parameter values of the simulated plant;
a calculating module, the calculating module being used for calculating values of characteristic indicators of the simulated plant; and
a depicting module, the depicting module being used for depicting characteristic curves of the simulated plant on a display interface based on the values of characteristic indicators of the simulated plant.

2. The autocontrol simulating system as claimed in claim 1, wherein the characteristic indicators of the simulated plant include a gain ratio of the simulated plant.

3. The autocontrol simulating system as claimed in claim 1, wherein the characteristic indicators of the simulated plant include a phase difference of the simulated plant.

4. The autocontrol simulating system as claimed in claim 1, further comprising a second adjusting module for adjusting parameter values of the simulated controller if the characteristic curves of the simulated plant are conformable to those of the plant.

5. The autocontrol simulating system as claimed in claim 4, further comprising an output module for outputting parameter values of the simulated controller.

6. The autocontrol simulating system as claimed in claim 4, wherein the parameter values of the simulated controller and the simulated plant are tested based on corresponding characteristic curves.

7. An autocontrol method for creating a simulated model representing an autocontrol system having a controller and a plant, the simulated model having a simulated controller and a simulated plant corresponding to the controller and the plant respectively, the autocontrol simulating method comprising:
loading parameter values of the controller, the parameter values of the controller being used as values of the simulated controller;
setting parameter values of the simulated plant;
calculating values of characteristic indicators of the simulated plant; and
depicting characteristic curves of the simulated plant based on the values of characteristic indicators.

8. The autocontrol simulating method as claimed in claim 7, further comprising steps of:
loading characteristic curves of the plant; and
comparing the characteristic curves of the simulated plant with the characteristic curves of the plant to determine whether the parameter values of the simulated plant is “satisfied”.

9. The autocontrol simulating method as claimed in claim 8, further comprising steps of:
adjusting parameter values of the simulated controller if the parameter values of the simulated plant is in a predetermined range of values;
calculating corresponding values for characteristic indicators of the simulated model; and
depicting corresponding characteristic curves of the simulated model.

10. The autocontrol simulating method as claimed in claim 9, further comprising a step of determining whether the parameter values of the simulated controller are in predetermined ranges of values based on the corresponding characteristic curves of the simulated model.

11. The autocontrol simulating method as claimed in claim 10, further comprising a step of outputting the parameter values of the simulated controller to the autocontrol system if the parameter values of the simulated controller are “satisfied”.

12. The autocontrol simulating method as claimed in claim 7, wherein the characteristic indicators include a gain ratio of the simulated plant.

13. The autocontrol simulating method as claimed in claim 7, wherein the characteristic indicators include a phase difference of the simulated plant.

14. A storage medium recorded with an application program, the application program having a computer executable steps of:
setting parameter values of a simulated model having a simulated controller, a simulated sensor, and a simulated plant;
calculating values for characteristic indicators of the simulated model; and
depicting characteristic curves of the simulated model based on the values for characteristic indicators of the simulated model.

15. The storage medium as claimed in claim 14, further comprising a step of comparing the characteristic curves of the simulated model with a predetermined characteristic curves to determine whether parameter values of the simulated plant is “satisfied”.

16. The storage medium as claimed in claim 15, further comprising a step of adjusting parameter values of the simulated plant whist fixing parameter values of the simulated controller and the simulated sensor if the parameter values of the simulated plant are “unsatisfied”.

17. The storage medium as claimed in claim 15, further comprising:
adjusting parameter values of the simulated controller if the parameter values of the simulated plant is tested to be “satisfied”;
calculating corresponding values for characteristic indicators of the simulated model; and
depicting corresponding characteristic curves of the simulated model.
